(19) United States
(12) Patent Application Publication
(10) Pub. No.: US 2008/0154735 A1
(43) Pub. Date: Jun. 26, 2008

(54) MOBILE VENDING PURCHASING

(76) Inventor: Mark Carlson, Half Moon Bay, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/749,366

(22) Filed: May 16, 2007

Related U.S. Application Data
(60) Provisional application No. 60/871,898, filed on Dec. 26, 2006.

(51) Int. Cl. G06Q 20/00; G06K 7/00; H04M 1/00

(52) U.S. Cl. 705/16; 235/381; 455/556.1

(57) ABSTRACT

A system and a method for using a portable consumer device such as a mobile phone for payments and the like are disclosed. One embodiment of the invention is directed to a method comprising receiving a payment request message from a portable consumer device operated by a consumer, wherein the payment request message includes a request to pay for a product from a vending machine, sending an authorization response message back to the vending machine wherein the vending machine subsequently prompts the consumer to enter a selection if the authorization response message indicates that the consumer is authorized to make a purchase, and receiving an acknowledgement message from the vending machine that the product was purchased.

### CROSS-REFERENCES TO RELATED APPLICATIONS

This patent application is a non-provisional of and claims priority to U.S. provisional patent application No. 60/871,898, filed on Dec. 26, 2006, which is herein incorporated by reference in its entirety for all purposes.

### BACKGROUND

Vending machines are common place today in a variety of locations and make available a wide selection of products for purchase. In a typical purchase transaction a consumer walks up to a vending machine, inserts small change or bills into the machine, makes a selection from the machine, and then the vending machine automatically dispenses the selected merchandise to the consumer. The problem is that a consumer either may not have cash on hand or may not have small bills or change to make the purchase. Further, vending machines are offering a more diverse variety of products to purchase than just the inexpensive small snacks, drinks and newspapers that were traditionally offered for sale in vending machines. For example, a consumer can purchase CDs or DVDs, prepaid telephone cards, or electronics from a vending machine. Thus, a simple cash purchase from the vending machine is becoming a less practical option.

To solve this problem a number of solutions have evolved. For example, many vending machines now have card readers so that a consumer can make purchase via a credit card or a prepaid card. More recently, some solutions have become available to purchase items from a vending machine via a mobile phone. However, these solutions require communication directly between the phone and the vending machine which requires special hardware to interact with different types of phones and a unique way for billing to occur to the consumer depending on the phone service the consumer subscribes to. For example, a consumer may be billed via her mobile phone company or she may have to subscribe to an entirely separate service that supports this type of transaction.

A better solution is required to allow a consumer to make a purchase from a vending machine via a mobile phone or other similar device, without the complexities of setting up different billing methods and equipment for each and every vending machine to interact with different types of mobile devices and with different billing companies. Embodiments of the invention address these and other problems individually and collectively.

### BRIEF SUMMARY

Embodiments of the invention are directed to systems and methods using portable consumer devices that can be used for payments and the like.

One embodiment of the invention is directed to a method comprising receiving a payment request message from a portable consumer device operated by a consumer, wherein the payment request message includes a request to pay for a product from a vending machine, sending an authorization response message back to the vending machine wherein the vending machine subsequently prompts the consumer to enter a selection if the authorization response message indicates that the consumer is authorized to make a purchase, and receiving an acknowledgement message from the vending machine that the product was purchased.

Another embodiment of the invention is directed to a method comprising reviewing contact information associated with a vending machine, sending a payment request message using the contact information and a portable consumer device wherein the vending machine subsequently receives an authorization response message indicating that payment is authorized and the vending machine thereafter prompts the consumer to make a selection, selecting a product in the vending machine, and receiving the product from the vending machine.

Another embodiment of the invention is directed to a method comprising receiving an authorization response message indicating that the consumer is authorized to make a purchase, prompting the consumer to enter a selection, and delivering an item corresponding to the selection to the consumer if the consumer makes the selection within a given amount of time.

Another embodiment of the invention is directed to a method comprising receiving a phone number associated with a vending machine and dialing the phone number, wherein after dialing, the vending machine subsequently receives authorization to dispense a product to a consumer operating the phone.

Another embodiment of the invention is directed to a method comprising automatically detecting a vending machine, prompting a consumer to enter information associated with the vending machine, and sending a payment request message wherein the vending machine subsequently receives authorization to dispense a product to the consumer.

These and other embodiments of the invention are described in further detail below.

### BRIEF DESCRIPTION OF THE DRAWINGS

FIG. 1 shows a block diagram of a system according to an embodiment of the invention.

FIG. 2 shows a block diagram of a vending machine according to an embodiment of the invention.

FIG. 3 shows a block diagram of a portable consumer device according to an embodiment of the invention.

FIG. 4 shows a block diagram of a payment processing network according to an embodiment of the invention.

FIG. 5 shows a flowchart illustrating steps in a method according to an embodiment of the invention.

FIG. 6 shows a flowchart illustrating steps in a method according to an embodiment of the invention.

FIG. 7 shows a flowchart illustrating steps in a method according to an embodiment of the invention.

FIG. 8(a) shows the display on an exemplary vending machine and mobile phone according to an embodiment of the invention.

FIG. 8(b) shows the display on an exemplary vending machine according to an embodiment of the invention.

FIG. 9(a) shows the display on an exemplary vending machine and mobile phone according to an embodiment of the invention.

FIG. 9(b) shows the display on an exemplary vending machine according to an embodiment of the invention.

FIG. 10(a) shows the display on an exemplary vending machine and mobile phone according to an embodiment of the invention.

FIG. 10(b) shows the display on an exemplary vending machine according to an embodiment of the invention.

### DETAILED DESCRIPTION

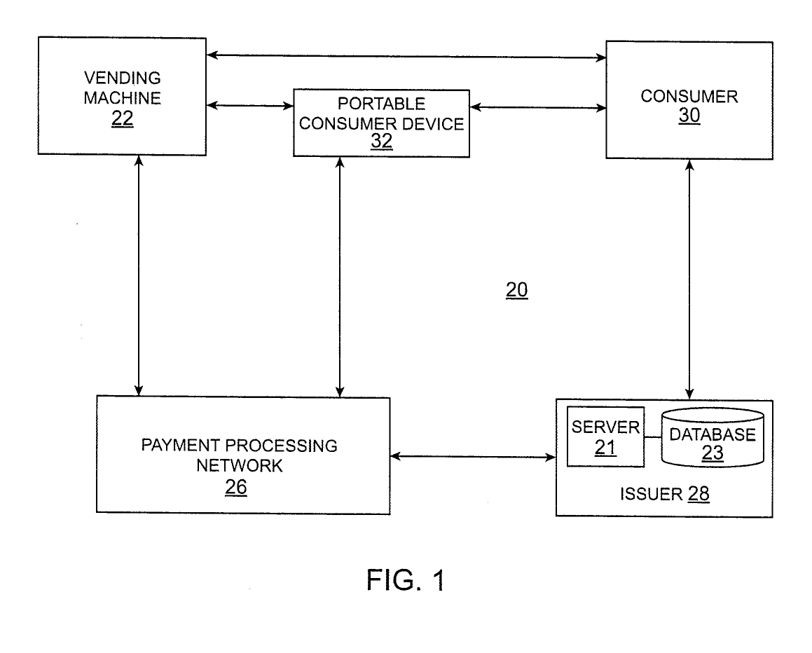

Embodiments of the invention are directed to the use of portable consumer devices, and methods and systems that use them. Preferred portable consumer devices are mobile phones. The mobile phones can be used in payment processing systems like those shown in FIG. 1.

In some embodiments of the invention, a payment request message is sent from a portable consumer device such as a phone, directly to a payment processing network such as VisaNet. As used herein, a “payment request message” may be an implicit or explicit request to pay for a product or selection. A payment request message may take different forms. For example, a payment request message may simply be in the form of a dialed telephone number. Dialing a dedicated telephone number associated with a vending machine can be an implicit request to pay for a product, as it does not contain an explicit payment message. In other embodiments, the payment request message may be embodied by an SMS message, an e-mail, or some other type of message. Such messages may or may not include an explicit request to pay. For example, sending any text message to a dedicated address may be an implicit payment request. Alternatively, a text message may be sent which says “Pay Vending Machine 346.” This is an explicit request to pay.

FIG. 1 shows a system 20 that can be used in an embodiment of the invention. For simplicity of illustration, one vending machine, one issuer, one portable consumer device, and one consumer are shown. It is understood, however, that embodiments of the invention may include multiple vending machines, issuers, portable consumer devices, and/or consumers. In addition, some embodiments of the invention may include fewer than all of the components shown in FIG. 1. Also, the components in FIG. 1 may communicate via any suitable communication medium (including the Internet), using any suitable communication protocol.

The system 20 includes a vending machine 22, a consumer 30, a payment processing network 26, a portable consumer device 32, and an issuer 28 associated with the portable consumer device 32. The portable consumer device 32 can communicate with the issuer 28 via the payment processing network 26.

The issuer 28 may be a bank, but it could also be business entity such as a retail store. The issuer 28 may operate a server computer 21, which may have a computer readable medium comprising code for performing the functions that the issuer 28 performs. A database 23 comprising account number information and other information may be operatively coupled to the server computer 21. The database 23 may comprise an account associated with the consumer 30 and the portable consumer device 32.

The consumer 30 may be an individual who may use the portable consumer device 32.

The vending machine 22 may be owned or leased by an entity such as an organization or business that sells goods using the vending machine 22. The vending machine 22 is typically a machine that dispenses products after a consumer 30 pays for the products. Examples of suitable products include food items (e.g., candy, gum, soft drinks, etc.), travel items, newspapers, tickets, movies, electronics, etc.

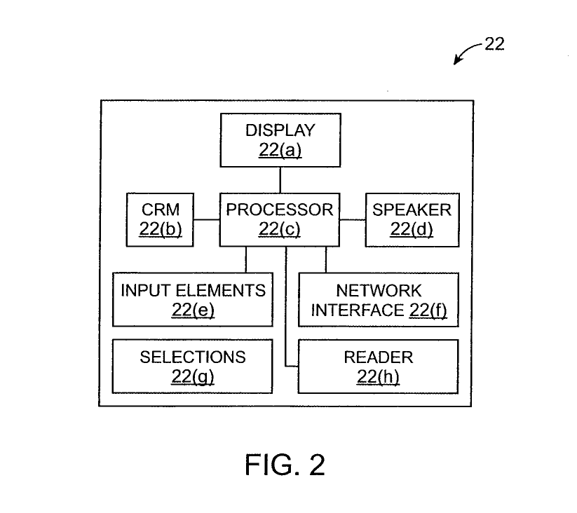

The vending machine 22 may contain components like those shown in FIG. 2. For example, the vending machine 22 may have a computer readable medium (“CRM”) 22(b) comprising code including instructions for performing the functions that the vending machine 22 performs, and a processor 22(c) to execute those instructions. The vending machine 22 may also have a display 22(a) to show messages to the consumer 30 and a speaker 22(d) to provide audio messages for the consumer 30. The vending machine 22 may also have input elements 22(e) (e.g., buttons, levers, or other actuators) to allow a consumer 30 to make a selection of one or more items to purchase from the vending machine 22, as well as a network interface 22(f) to communicate with a payment processing network 26 so that the vending machine 22 can communicate during the payment authorization process. The vending machine 22 may also have one or more selections 22(g) of items for a consumer 30 to purchase. Selections 22(g) may comprise products such as food items (e.g., candy, gum, soft drinks, etc.), travel items, etc.

The vending machine 22 may also have, or may receive communications from, a reader 22(h) that can interact with the portable consumer device 32. The reader 22(h) may include any suitable contact or contactless mode of operation. For example, exemplary card readers can include RF (radio frequency) antennas, magnetic stripe readers, etc. to interact with the portable consumer device 32. Contactless readers are commercially available. Suitable equipment for allowing the vending machine 22 to function in embodiments of the invention can be purchased from Bonusdata AG.

The portable consumer device 32 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular and mobile phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

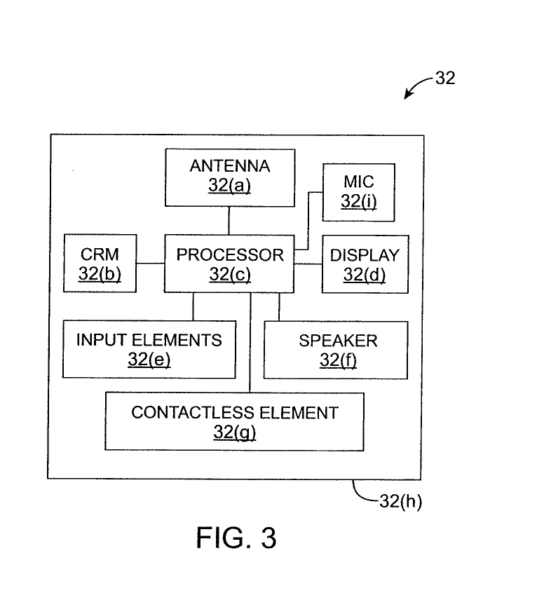

The portable consumer device 32 may comprise a computer readable medium 32(b) and a body 32(h) as shown in FIG. 3. The computer readable medium 32(b) present within body 32(h), or may be detachable from it. The body 32(h) may in the form a plastic substrate, housing, or other structure. The computer readable medium 32(b) may be a memory that stores data and may be in any suitable form including a magnetic stripe, a memory chip, etc.

If the computer readable medium 32(b) is in a phone, it may comprise code for receiving a phone number and a payment request message from a consumer, wherein the payment request message includes a request to pay for a product from a vending machine. It may also comprise code for dialing the phone number; and code for sending a payment request message where the vending machine subsequently receives an authorization response message indicating that payment is authorized (or not authorized), where the vending machine thereafter prompts the consumer to make a selection.

The portable consumer device 32 may further include a contactless element 32(g), which is typically implemented in the form of a semiconductor chip (or other data storage element) with an associated wireless transfer (e.g., data transmission) element, such as an antenna. Contactless element 32(g) is associated with (e.g., embedded within) portable consumer device 32 and data or control instructions transmitted via a cellular network may be applied to contactless element 32(g) by means of a contactless element interface (not shown). The contactless element interface functions to permit the exchange of data and/or control instructions between the mobile device circuitry (and hence the cellular network) and an optional contactless element 32(g).

Contactless element 32(g) is capable of transferring and receiving data using a near field communications (“NFC”) capability (or near field communications medium) typically in accordance with a standardized protocol or data transfer mechanism (e.g., ISO 14443/NFC). Near field communications capability is a short-range communications capability, such as RFID, Bluetooth™, infra-red, or other data transfer capability that can be used to exchange data between the portable consumer device 32 and a payment processing network 26 or it can be used to exchange data between the portable consumer device 32 and the vending machine 22. Thus, the portable consumer device 32 is capable of communicating and transferring data and/or control instructions via both cellular network and near field communications capability.

The portable consumer device 32 may also include a processor 32(c) (e.g., a microprocessor) for processing the functions of the portable consumer device 32 and a display 32(d) to allow a consumer to see phone numbers and other information and messages. The portable consumer device 32 may further include input elements 32(e) to allow a consumer to input information into the device, a speaker 32(f) to allow the consumer to hear voice communication, music, etc., and a microphone 32(i) to allow the consumer to transmit her voice through the portable consumer device 32. The portable consumer device 32 may also include an antenna 32(a) for wireless data transfer (e.g., data transmission).

Referring to FIG. 1 again, the payment processing network 26 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

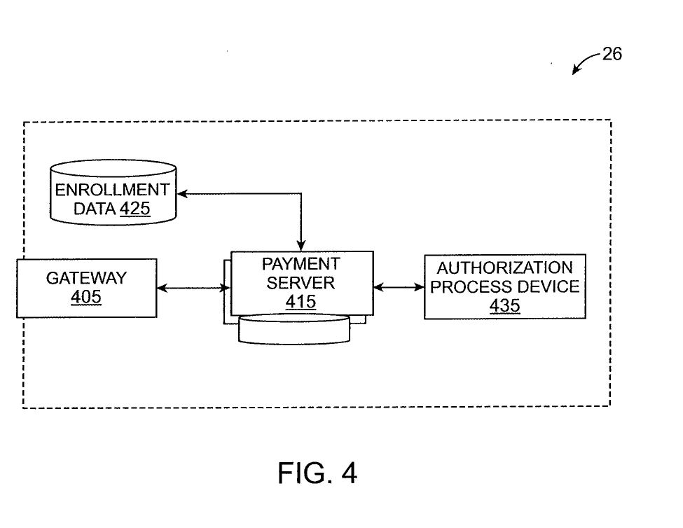

Specifically, the payment processing network 26 may include a server computer 415 as shown in FIG. 4. As used herein, a “server computer” is typically a powerful computer or cluster of computers. For example, a server computer can be a large mainframe, a minicomputer cluster, or a group of servers functioning as a unit. In one example, the server computer may be a database server coupled to a Web server. The payment processing network 26 may use the server computer 415, and the server computer 415 may be present in any suitable wired or wireless network, including the Internet.

The payment processing network 26 may further include a gateway 405 whereby a dial request, text message or Short Message Service (“SMS”) message, for example, from a portable consumer device 32, can pass through to the payment processing network 26. (SMS is typically a service available on a portable consumer device that permits the sending of short messages between portable consumer devices via an intermediate server.) The gateway 405 may be embodied by a computer or a network that allows or controls access to another computer or network. The gateway 405 may also be a software interface between the computer or network and another computer or network.

In this example, the payment server 415 can validate and augment a payment request message received from the portable consumer device 32. It can log the payment request message, and transmit the payment request message to the authorization process device 435 where it is formatted and transmitted to the issuer 28 for the portable consumer device 32. The payment processing network 26 may also include an enrollment database 425 that stores portable consumer device enrollment data for verification and logging purposes.

An acquirer (which is not shown in FIG. 1) such as a bank may be in electronic communication with the payment processing network 26, and the issuer 28. It may also be in electronic communication with the vending machine 22, and other vending machines, and/or an organization that owns or operates the vending machines. In embodiments of the invention, the vending machine 22 may communicate directly with the payment processing network 26 or through an acquirer.

Referring to FIGS. 1-3, in one purchase transaction embodiment, a consumer 30 may use a portable consumer device 32 to directly contact the payment processing network 26 to obtain authorization to make a purchase. In this embodiment, the portable consumer device 32 does not directly communicate with the vending machine 22 when the purchase is made. In this example, a payment request message is sent from the portable consumer device 32 to the payment processing network 26. The payment processing network 26 then forwards the payment request message to the issuer 28 of the portable consumer device 32.

After the issuer 28 receives the authorization request message, the issuer 28 sends an authorization response message back to the payment processing network 26 to indicate whether or not the current transaction is authorized. The issuer 28 may require additional information from the consumer 30 such as a PIN before sending the authorization response message to the vending machine 22 and/or the portable consumer device 32. The transaction processing network 26 then forwards the authorization response message to the vending machine 22.

After the vending machine 22 receives the authorization response message, the authorization response message may be displayed by the vending machine 22 display 22(a) or the vending machine 22 may voice the response message via the speaker 22(d). Once the vending machine 22 receives approval for the payment, the vending machine 22 may prompt the consumer 30 to make a selection. The consumer 30 may then select a product as she would with a conventional vending machine and the product may thereafter be dispensed to the consumer 30.

At the end of the day, a normal clearing and settlement process can be conducted by the transaction processing network 26. A clearing process is a process of exchanging financial details between the payment processing network 26, the issuer 28, and the vending machine 22, or potentially an acquirer associated with the vending machine 22. To facilitate posting to a consumer's account and reconciliation of the consumer's settlement position. As noted above, the acquirer (which is not shown in FIG. 1), may be bank that is electronically coupled to the payment processing network 26, the issuer 28, and the vending machine 22.

Some of the embodiments described below may use a payment processing system like the one described above, or any suitable combination of components in the payment processing system. More specific embodiments of the invention are described below.

Other embodiments of the invention, which specifically use a mobile phone, are described in further detail below. The embodiments can use dial, interactive voice response (“IVR”), or an entered message which is sent to a payment processing network. These embodiments may further use a payment processing network such as VisaNet to authorize the transaction and tell the vending machine that payment has been accepted. By using a payment processing network such as VisaNet, there is no need to set up a separate billing situation for each mobile phone service organization or set up a separate billing service for a particular vending machine. The payment processing network, such as VisaNet, interacts with each different billing organization so that all transactions appear the same to the vending machine.

Additional details regarding embodiments of the invention are described below.

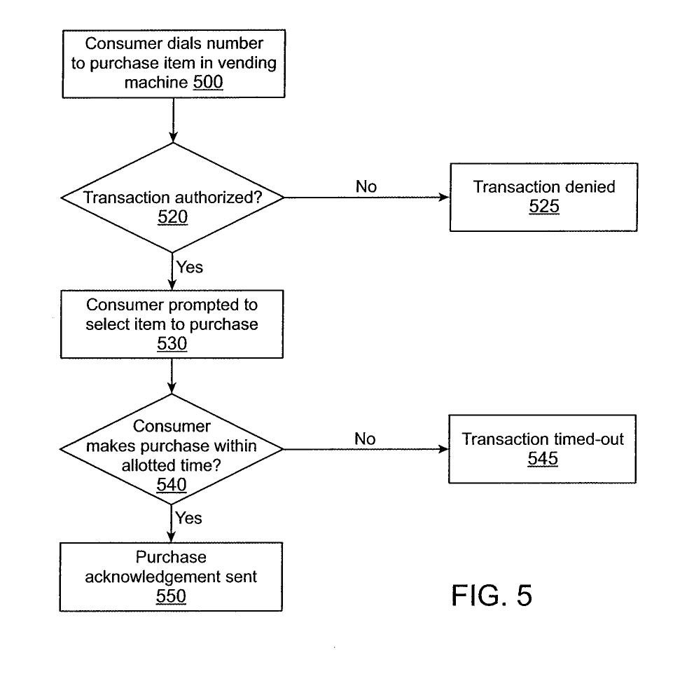

FIG. 5 shows a flowchart including a method according to a first embodiment of the invention. The method can be described with reference to FIGS. 1-4, 8(a), and 8(b).

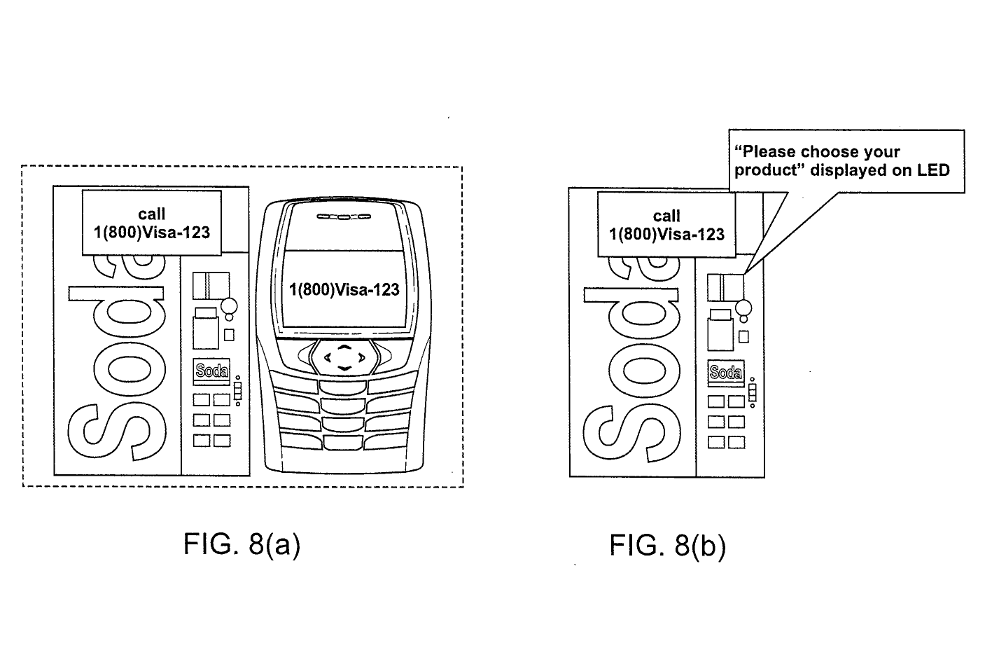

First, a consumer 30 enters a telephone number associated with the vending machine 22 in using input elements 32(e) in the portable consumer device 32 to purchase one or more selections 22(g) from the vending machine 22 (step 500). As shown in FIG. 8(a), the number may be posted (e.g., through a static medium such as plastic or paper, or through a dynamic medium such as an LCD screen) on the vending machine 22. Alternatively, it may be provided to the consumer 30 in some other way (e.g., a mailing, an e-mail, an SMS message, etc.).

Referring to FIG. 4, a payment request message is then sent from the portable consumer device 32 to the payment processing network 26 via a gateway 405. The gateway 405 passes the payment request message to the payment server 415. The payment server 415 validates the payment request message against the data in the database containing the enrollment data 425 and augments the payment request message. The payment server 415 then passes the payment request message to the authorization process device 435 where it is formatted and passed to the issuer 28 of the portable consumer device 32.

After the issuer 28 receives the payment request message, the issuer 28 analyzes the payment request message and sends an authorization response message back to the payment server 415 to indicate whether or not the current transaction is authorized. The payment server 415 logs the response and sends the authorization response message to the vending machine 22. If the transaction is not authorized (step 520), the vending machine 22 notifies the consumer 30 that the transaction is denied (step 525). If the transaction is authorized (step 520), the vending machine 22 prompts the consumer 30 to select an item to purchase (step 530) within an allotted time (e.g., twenty seconds or less). For example, the vending machine 22 may display a message that says “Please choose your product,” as shown in FIG. 8(b).

If the consumer 30 does not make the purchase within the allotted time (step 540) the transaction times-out (step 545) and the consumer 30 initiates another payment request to purchase an item. If the consumer 30 does make the purchase within the allotted time (step 540) then the selected item is delivered to the consumer 30 and a purchase acknowledgement is sent to the payment processing network 26 (step 550). The purchased item will appear on the consumer's next statement.

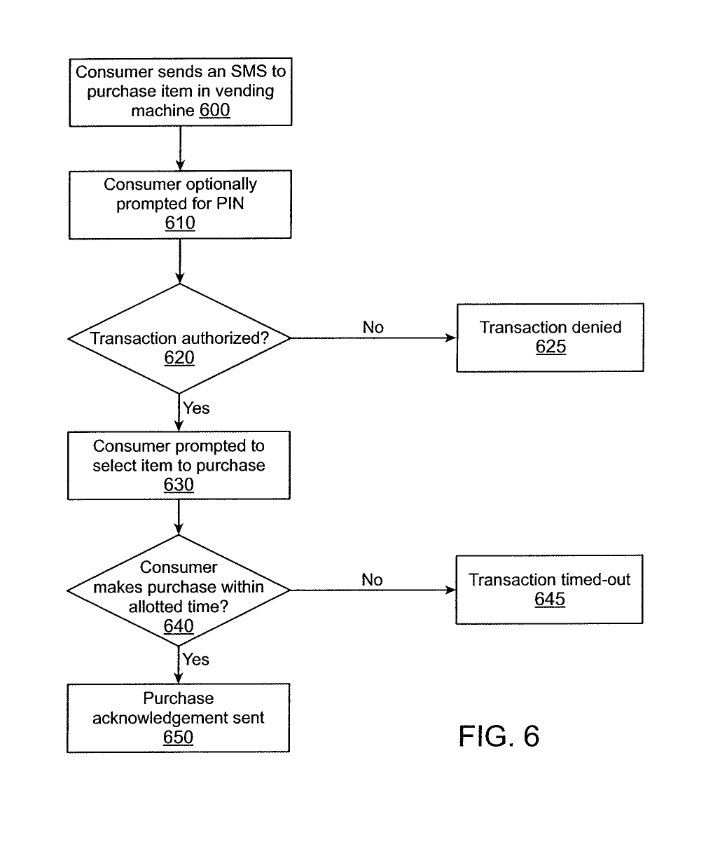

FIG. 6 shows a flowchart including a general method according to a second embodiment of the invention. The method can be described with reference to FIGS. 1-4, 9(a), and 9(b).

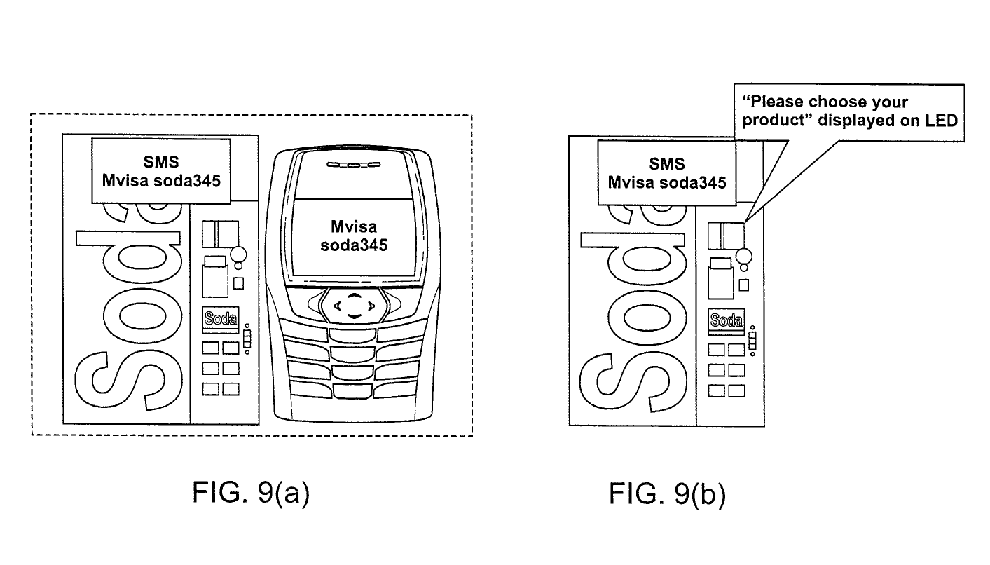

First, the consumer 30 sends an SMS to the number associated with the vending machine 22 to purchase an item in the vending machine 22 (step 600). As shown in FIG. 9(a), the number may be posted on the vending machine 22. Alternatively, it may be provided to the consumer 30 in some other way (e.g., a mailing, an e-mail, an SMS message, etc.).

Referring to FIG. 4, a payment request message is then sent from the portable consumer device 32 to the payment processing network 26 via a gateway 405. The gateway 405 passes the payment request message to the payment server 415. The payment server 415 validates the payment request message against the data in the database containing the enrollment data 425 and augments the payment request message. The payment server 415 then passes the payment request message to the authorization process device 435 where it is formatted and passed to the issuer 28 of the portable consumer device 32.

The issuer 28 may require a PIN from the consumer 30 before sending an authorization response message. If this is the case, then after the issuer 28 receives and analyzes the payment request message, the issuer 28 sends a PIN request back to the payment server 415 and the payment server 415 sends the PIN request to the portable consumer device 32. The PIN request may be in audio or textual form.

Next the consumer 30 is prompted to enter a PIN (step 610) into the portable consumer device 32. The PIN is then sent from the portable consumer device 32 to the payment processing network 26 via a gateway 405. The gateway 405 passes the PIN to the payment server 415. The payment server 415 then passes the PIN to the issuer 28 of the portable consumer device 32.

After the issuer 28 receives the PIN, the issuer 28 verifies that the PIN matches the PIN associated with the consumer 30. After verifying the PIN (or if the issuer 28 did not require a PIN) the issuer 28 sends an authorization response message back to the payment server 415 to indicate whether or not the current transaction is authorized. The payment server 415 logs the response and sends the authorization response message to the vending machine 22. If the transaction is not authorized (step 620), the vending machine 22 notifies the consumer 30 that the transaction is denied (step 625). If the transaction is authorized (step 620), the vending machine 22 prompts the consumer 30 to select an item to purchase within an allotted time (e.g., twenty seconds or less) (step 630). For example, the vending machine 22 may display a message that says “Please choose your product,” as shown in FIG. 9(b).

If the consumer 30 does not make the purchase within the allotted time (step 640) the transaction times-out (step 645) and the consumer 30 initiates another payment request to purchase an item. If the consumer 30 does make the purchase within the allotted time (step 640) then the item selected is delivered to the consumer 30 and a purchase acknowledgement is sent to the payment processing network 26 (step 650). The purchased item will appear on the consumer's next statement.

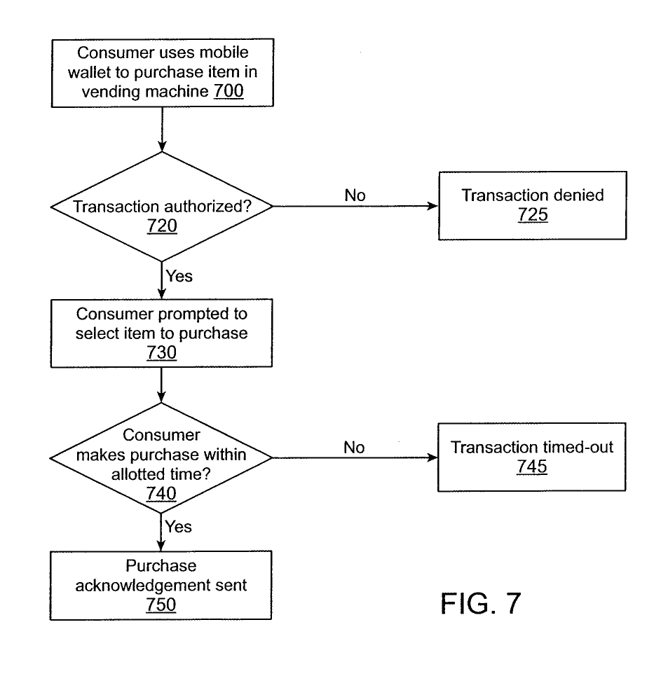

FIG. 7 shows a flowchart including a general method according to a third embodiment of the invention. The method can be described with reference to FIGS. 1-4, 10(a), and 10(b).

In this embodiment of the invention, a consumer 30 may use a mobile wallet to make a vending purchase (step 700). A mobile wallet is a payment enabled mobile phone that functions as a payment mechanism similar to a debit card, credit card, or prepaid card. For example a consumer 30 may register her credit card with the issuer 28 of the portable consumer device 32 and then use the mobile phone to make purchases or a consumer 30 may set up a prepaid account with the issuer 28 of the portable consumer device 32 or another entity that she can draw against to make purchases.

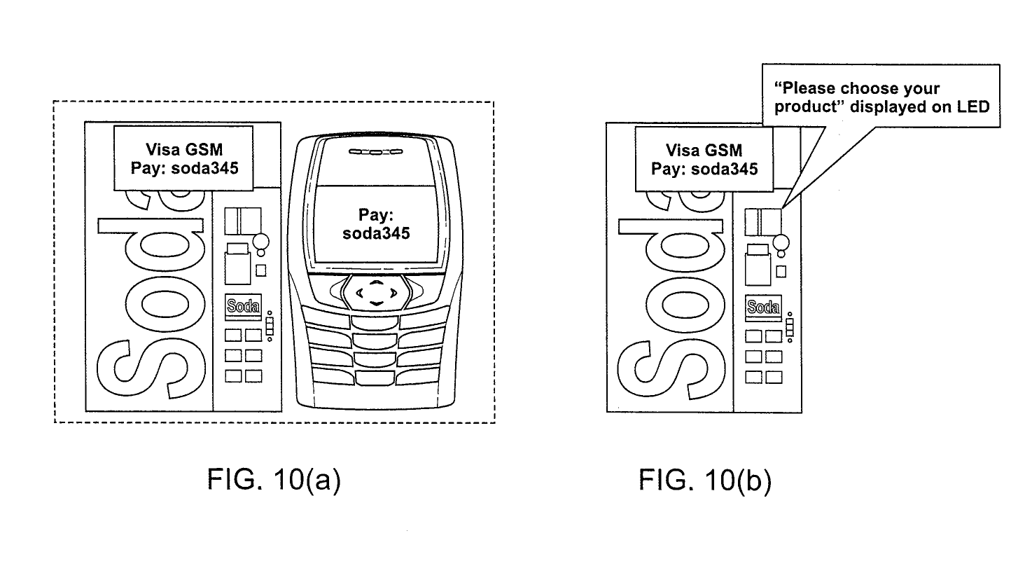

First, the consumer 30 may launch an application in the portable consumer device 32 and type in a machine alias associated with the vending machine 22 (e.g., “Pay: coke345”) as shown in FIG. 10(a). Alternatively, the portable consumer device 32 may automatically detect the vending machine 22 (via RFID, etc.) and prompt the consumer 30 to enter information (e.g., a machine alias, payment information, etc.) associated with the vending machine 22, such as a machine alias shown in FIG. 10(a). As shown in FIG. 10(a), the machine alias may be posted on the vending machine 22. The consumer 30 may also be required to enter a PIN to authenticate the transaction.

Referring to FIG. 4, a payment request message is then sent from the portable consumer device 32 to the payment processing network 26 via a gateway 405. The gateway 405 passes the payment request message to the payment server 415. The payment server 415 validates the payment request message against the data in the database containing the enrollment data 425 and augments the payment request message. The payment server 415 then passes the payment request message to the authorization process device 435 where it is formatted and passed to the issuer 28 of the portable consumer device 32.

After the issuer 28 receives the payment request message, the issuer 28 analyzes the payment request message, and sends an authorization response message back to the payment server 415 to indicate whether or not the current transaction is authorized. The payment server 415 logs the response and sends the authorization response message to the vending machine 22. If the transaction is not authorized (step 720), the vending machine 22 notifies the consumer 30 that the transaction is denied (step 725). If the transaction is authorized (step 720), the vending machine 22 prompts the consumer 30 to select an item to purchase (step 730) within an allotted time (e.g., twenty seconds or less). For example, the vending machine 22 may display a message that says “Please choose your product,” as shown in FIG. 10(b).

If the consumer 30 does not make the purchase within the allotted time (step 740) the transaction times-out (step 745) and the consumer 30 initiates another payment request to purchase an item. If the consumer 30 does make the purchase within the allotted time (step 740) then the selected item is delivered to the consumer 30 and a purchase acknowledgement is sent to the payment processing network 26 (step 750). The purchased item will appear on the consumer's next statement.

Other alternative embodiments are also possible. For example, although the examples described above request the consumer to make a selection, in other embodiments, the consumer may actually input the selection that the consumer wants into the portable consumer device (e.g., phone) before the purchase is made. For example, the consumer may dial a phone number on a vending machine, and may thereafter get an automatic callback from a payment processing network requesting that the consumer enter the number of the product desired. The consumer may then enter the number “13” into his phone, and the vending machine may automatically dispense the product associated with this number. In this embodiment, the consumer may not directly interact at all with the vending machine during the payment process. In another example, the consumer may simply enter information such as “pay vending machine 345 $2.00, and dispense product 13”. This information may be sent to a payment processing and the payment processing network may thereafter automatically dispense the desired product.

Embodiments of the invention have a number of advantages. First, embodiments of the invention can contact a payment processing network directly, without requiring the consumer to initially interact with the vending machine. Thus, in some cases, it is not necessary that the vending machine have some interface (e.g., a contactless reader) that needs to interact with the consumer's portable consumer device. Since such specialized readers are not required, this makes it more likely that embodiments of the invention can be universally implemented. Also, the communication between the portable consumer device and the payment processing network is more direct in embodiments of the invention than conventional payment processing systems. This can reduce the likelihood of communication errors in the payment process. Also, by contacting the payment processing network directly (rather than a phone company first), the payment processing network can log and process the transaction like any other credit or debit card payment transaction.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving a payment request message from a portable consumer device operated by a consumer, wherein the payment request message includes a request to pay for a product from a vending machine;
sending an authorization response message back to the vending machine wherein the vending machine subsequently prompts the consumer to enter a selection if the authorization response message indicates that the consumer is authorized to make a purchase; and
receiving an acknowledgement message from the vending machine that the product was purchased.

2. The method of claim 1 further comprising analyzing the payment request message to determine if the consumer is authorized to pay for the product.

3. The method of claim 1 further comprising automatically calling the portable consumer device and requesting that the consumer enter a PIN into the device.

4. The method of claim 1 wherein the payment request message is received by a payment processing network, and wherein the payment request message does not pass directly from the portable consumer device to the vending machine.

5. The method of claim 1 wherein the portable consumer device is a wireless phone.

6. A computer readable medium comprising:
code for receiving a payment request message from a portable consumer device operated by a consumer, wherein the payment request message includes a request to pay for a product from a vending machine;
code for sending an authorization response message back to the vending machine wherein the vending machine subsequently prompts the consumer to enter a selection if the authorization response message indicates that the consumer is authorized to make a purchase; and
code for receiving an acknowledgement message from the vending machine that the product was purchased.

7. A server comprising the computer readable medium of claim 6.

8. A method comprising:
reviewing contact information associated with a vending machine;
sending a payment request message using the contact information and a portable consumer device wherein the vending machine subsequently receives an authorization response message indicating that payment is authorized and the vending machine thereafter prompts the consumer to make a selection;
selecting a product in the vending machine; and
receiving the product from the vending machine.

9. The method of claim 8 wherein the portable consumer device is a wireless phone.

10. A method comprising:
receiving an authorization response message indicating that the consumer is authorized to make a purchase;
prompting the consumer to enter a selection; and
delivering an item corresponding to the selection to the consumer if the consumer makes the selection within a given amount of time.

11. The method of claim 10 wherein the given amount of time is twenty seconds or less.

12. A vending machine adapted to perform the method of claim 10.

13. A method comprising:
receiving a phone number associated with a vending machine; and
dialing the phone number, wherein after dialing, the vending machine subsequently receives authorization to dispense a product to a consumer operating the phone.

14. A computer readable medium comprising:
code for receiving a phone number associated with a vending machine; and
code for dialing the phone number, wherein after dialing, the vending machine subsequently receives authorization to dispense a product to a consumer operating the phone.

15. A wireless phone comprising the computer readable medium of claim 14.

16. A method comprising:
automatically detecting a vending machine;
prompting a consumer to enter information associated with the vending machine; and
sending a payment request message wherein the vending machine subsequently receives authorization to dispense a product to the consumer.

17. The method of claim 16 further comprising prompting the consumer to enter a PIN.

18. A computer readable medium comprising:
code for automatically detecting a vending machine;
code for prompting a consumer to enter information associated with the vending machine; and
code for sending a payment request message wherein the vending machine subsequently receives authorization to dispense a product to the consumer.

19. A wireless phone comprising the computer readable medium of claim 18.
